(19) United States
(12) Patent Application Publication
(10) Pub. No.: US 2008/0275736 A1
(43) Pub. Date: Nov. 6, 2008

(54) System of Picture Archiving and Communication System With Message Broadcasting Mechanism

(75) Inventor: Weng I. Lei, Mount Prospect, IL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 11/837,816

(22) Filed: Aug. 13, 2007

Related U.S. Application Data
(60) Provisional application No. 60/916,005, filed on May 4, 2007.

(51) Int. Cl. G06Q 50/00

(52) U.S. Cl. 705/3

(57) ABSTRACT

A method for medical scan archiving and notifying medical professionals of a need for evaluation of the medical scan, having the steps of enrolling a medical professional in a computer system, the enrolling of the medical professional including a medical professional type, gathering medical data from the patient, entering the medical data gathered from the patient, an urgency type for the patient, and a medical data type for the patient into a data archival system, evaluating the urgency type for the patient related to the medical data, and conducing a broadcast message to a medical professional with a medical professional type corresponding to the medical data type when the urgency type corresponds to a need for immediate reading of the medical data for the patient.

### CROSS-REFERENCE TO RELATED APPLICATIONS

This is a United States non-provisional application of U.S. provisional patent application Ser. No. 60/916,005 filed May 4, 2007 by Weng I Lei the entirety of which application is incorporated by reference herein.

### FIELD

The present invention relates to a system and method for medical data scan archiving. More specifically, the invention provides a message broadcast mechanism for Picture Archiving And Communication Systems (PACS) to alert medical professional of the need to evaluate the medical data scans and retrieve outdated message broadcasts.

### BACKGROUND INFORMATION

Evaluation of medical data, such as body scans, by medical professionals is a necessary and important process in medical care. Systems used by medical professionals must have the ability to accurately present the data to medical evaluative professionals. The systems must also allow for storage of this data for archival purposes.

Under certain conditions for medical patients, evaluations are to be performed in a weekly time frame as no emergency is present for the patient. In emergency situations, however, the data must be evaluated on a quicker interval. In these emergency situations, if medical professionals are not immediately present, the medical data goes unread, delaying patient care.

There is therefore a need to provide a method and apparatus to notify medical professionals, such as radiologists, that examination of medical data should commence when data is ready.

There is a further need to provide a method and apparatus to minimize time lag between preparation of medical data and evaluation by medical professionals so that patients receive immediate care.

There is a still further need to provide a method and system that will minimize the need for emergency examination readings that are not necessarily needed to be processed on an expedited basis.

There is also a need to provide a method and system that will discriminate between data types and subsequently allow notification of appropriate medical professionals based upon the data type required to be evaluated.

### SUMMARY

It is therefore an objective to provide a method and apparatus to notify medical professionals, such as radiologists, that examination of medical data should commence.

It is a further objective to provide a method and apparatus to minimize time lag between preparation of medical data and evaluation by medical professionals so that patients receive immediate care.

It is a still further objective to provide a method and system that will minimize the need for emergency examination readings that are not necessarily needed to be processed on an expedited basis.

It is also an objective to provide a method and system that will discriminate between the data types and subsequently allow notification of appropriate medical professionals based upon the data type required to be evaluated.

The objectives are achieved as illustrated and described. The present invention provides for a method for medical scan archiving and notifying medical professionals of a need for evaluation of the medical scan, comprising the steps of enrolling a medical professional in a computer system, the enrolling of the medical professional including a medical professional type, gathering medical data from the patient, entering the medical data gathered from the patient, an urgency type for the patient, and a medical data type for the patient into a data archival system, evaluating the urgency type for the patient related to the medical data, and conducting a broadcast message to a medical professional with a medical professional type corresponding to the medical data type when the urgency type corresponds to a need for immediate reading of the medical data for the patient.

In another exemplary embodiment, the urgency type for the patient is at least one of a modality categorization, an exam priority categorization, a study data categorization and a time categorization.

The method may further comprise the step of reading the medical data by a medical professional. Additionally, the method may comprise the step of changing the urgency type in the data archival system after the reading of the medical data by the medical professional. The method may also be conducted such that the medical data type has different modalities, such as a magnetic resonance image or a computed tomography image.

The method may also further comprise the step of creating a notification list of medical professionals of a same medical professional type, wherein the conducting of the broadcast message to the medical professional with the medical professional type corresponding to the medical data type when the urgency type corresponds to a need for immediate reading of the medical data for the patient is done through contacting medical professionals on the notification list.

An embodiment of the present invention also provides a program storage device readable by machine, tangibly embodying a program of instructions executable by the machine to perform method steps for medical scan archiving and notifying medical professionals of a need for evaluation of the medical scan, comprising the steps of enrolling a medical professional in a computer system, the enrolling of the medical professional including a medical professional type, gathering medical data from the patient, entering the medical data gathered from the patient, an urgency type for the patient, and a medical data type for the patient into a data archival system, evaluating the urgency type for the patient related to the medical data, and conducting a broadcast message to a medical professional with a medical professional type corresponding to the medical data type when the urgency type corresponds to a need for immediate reading of the medical data for the patient.

The program storage device may also be accomplished such that the urgency type for the patient is one of a modality categorization, an exam priority categorization, a study data categorization and a time categorization. The program storage device may also include the capability of providing method steps of verifying the urgency type for the patient after the step of evaluating the urgency type for the patient related to the medical data and before the step of conducting the broadcast message to the medical professional.

The program storage device may also be configured such that the method performed comprises the step of reading the medical data by a medical professional.

The program storage device may also be configured such that the method performed further comprises the step of changing the urgency type in the data archival system after the reading of the medical data by the medical professional. The medical data type may be a magnetic resonance image or a computed tomography image.

The program storage device may also be performed such that the method further comprises, creating a notification list of medical professionals of a same medical professional type; wherein the conducting of the broadcast message to the medical professional with the medical professional type corresponding to the medical data type when the urgency type corresponds to a need for immediate reading of the medical data for the patient is done through contacting medical professionals on the notification list.

An embodiment of the present invention also provides an apparatus for medical data retention and medical professional notification, the apparatus comprising a computer workstation configured to enter and display patient information medical data scans, a broadcast module, and a computer server connected to the computer workstation, the computer server configured to store the medical data scans patient information, the computer server also having a messaging module connected to the broadcast module, wherein the messaging module is configured to activate the broadcast module to send a message to a medical professional at a location remote from the computer workstation and the computer server based upon a predefined status of the patient information.

### BRIEF DESCRIPTION OF THE DRAWINGS

FIG. 1 is a exemplary method of a picture archiving and message broadcasting mechanism.

FIG. 2 is an arrangement to perform the method of picture archiving and message broadcasting of FIG. 1.

### DETAILED DESCRIPTION

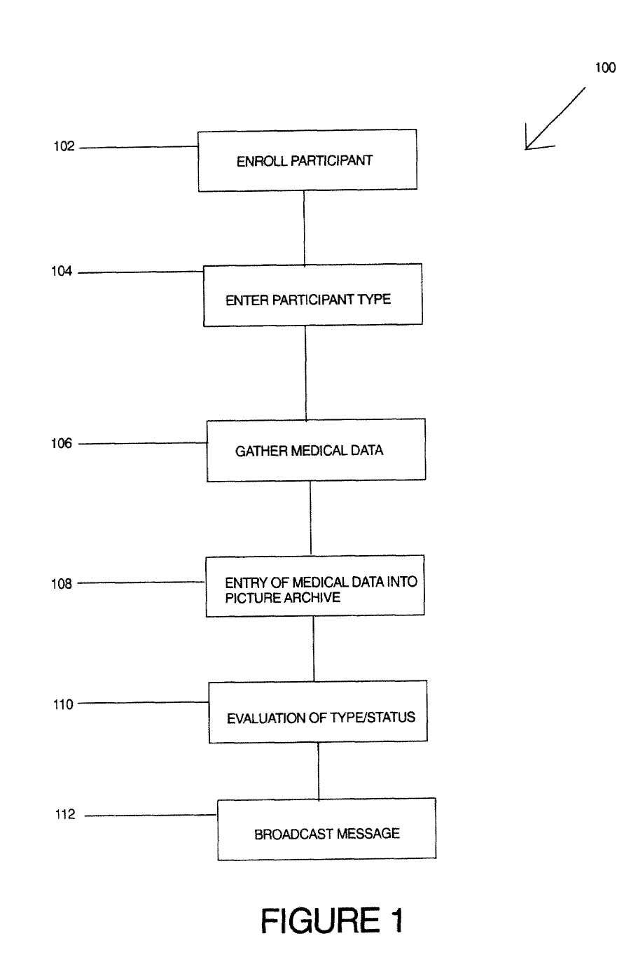

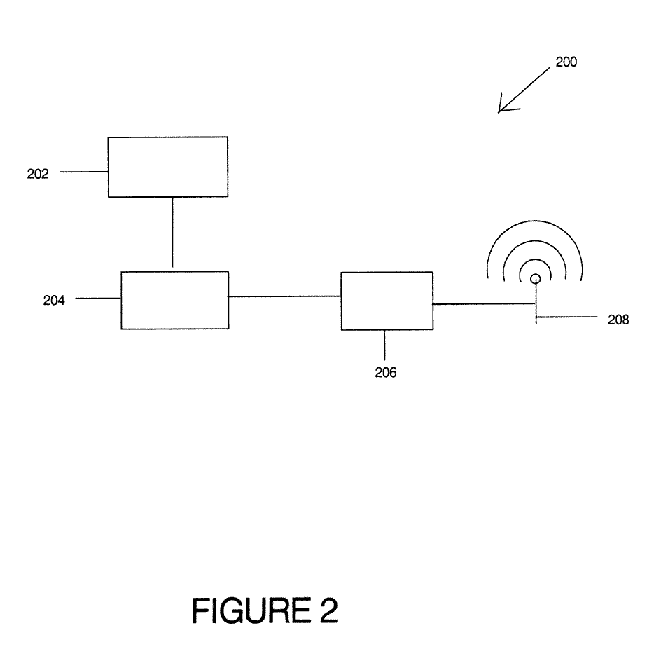

Referring to collectively to FIGS. 1 and 2, an exemplary embodiment of a method 100 for medical scan archiving and notifying medical professionals of a need for evaluation of the medical scans is presented. The method 100, first incorporates the step of enrolling a medical professional in a computer system, the enrolling of the medical professional including a medical professional type 102. In the illustrated exemplary embodiment, the medical professional is a radiologist, however other types of medical professionals may also use the system 200 and be entered into the system 200. As will be understood, more than one medical professional may be entered into the system 200. Thus, several different types of medical professionals may be entered into the system 200 and the system 200 may categorize the medical professionals into discrete subgroups of areas of expertise. This can include, for example, a radiologist who specializes in reading magnetic resonance images as compared to computed tomography images. The system 200 may also be used by other types of medical professionals, such as dentists, nurses or technologists, who specialized in complex oral surgery in who evaluate complex data stored in data storage systems. Each of the medical professionals are provided with a mobile communication device to receive messages emanating from the system 200. As a result, the system 200 may notify individual doctors, on an as-needed basis.

Next, medical data is gathered from the patient 106. The medical data gathered from the patient may be of various types, including those specifically pertaining to visual records of patents, such as for magnetic resonance images, computed tomography scans, dental records and x-ray evaluations.

The medical data (scans) are then stored 108 in an arrangement, such as a PACS system such that the information is archived for future use. In one embodiment, the data stored is a magnetic resonance image that is downloaded into a computer server arrangement 204. The computer server 204 may be interconnected with other computer servers such that data may freely flow between computer systems. Thus, a person reading the medical data can be in a different location than the place that the computer data is stored, allowing medical professionals flexibility in staffing at different locations.

In addition to the provision of the medical data (scans) to the computer server 204, an urgency type for the patient, and a medical data type for the patient are also entered. The urgency type for the patient is related to the needed priority of the evaluative results. The urgency type may be configured to use any exam properties, such as modality type, exam priority, study date and time as non-limiting examples. Patient particulars may also be entered into the computer server 204, for example, patients contact information, insurance information as non-limiting examples. Other types of information may also be entered such that properties used to configure evaluation times, such as SQL Boolean expressions.

The method 100 then evaluates the urgency type 110 for the patient related medical data. Based upon the urgency type 110 of the patient related medical data, a broadcast message to a medical professional with a medical professional type corresponding to the medical data type when the urgency type corresponds to a need for immediate reading of the medical data for the patient 112. When needed by a requesting physician (i.e. the physician requires immediate analysis of data), the system 200 allows for a broadcast to be made to ensure that attention is noted for the medical professionals conducting data evaluation. The broadcast may be made by computer email, text message, or other electronic notification to the medical professional who is performing the evaluation.

The broadcast message may reside in the computer server 204 that is responsible for broadcasting messages to registered individuals. The messaging module also examines/monitors the examination status of the data within the system 200. In one embodiment of the invention, the messaging module tracks information within the system 200 such that the patient data has an examination status of verified, dictated and approved and sends out messages accordingly to medical professionals charged with reading the patient data. If examination data satisfy a given configuration criteria, the messaging module will send out messages to all subscribers with the following content: patient name, study date and time, study instance UID (unique identification number), Modality, Exam Status and Procedure name. Any messages produced by the messaging module may be accompanied by any exam or study related properties, as determined by the medical professional using the system. The UID is a unique identification number that is particular to the data of the particular data set for a patient. The arrangement 200 uses the unique identification number in determining the status of the data set, either arrived, verified, dictated or approved.

In an exemplary embodiment of the present invention, there are four exam status indicators for data present within the arrangement 200. The four exam status indicators in the systems are 1) Arrived, 2) Verified, 3) Dictated and 4) Approved. In the “Arrived” status, the data/images have been acquired and are present within the system. In the “Verified” status, an exam has been verified by technologists that data/images of the exam are of a correct number and of the correct patient, thus the scans are ready for reading. In the “Dictated” status, the exam has been dictated by a staff medical professionals or residents, for example, and the report has been created. In the “Approved” status, the diagnostic report has been finalized and approved by a staff radiologist.

Referring to FIG. 2, illustrating the system 200, when medical data (image) is “Verified”, the workstation 202 sends a request to the server 204 to change the data status to “Verified”. In the “Verified” status, the data is ready to be evaluated. As a messaging module resides in the server 204, the server 204 is able to update the broadcast module 206 to send information to broadcast module 206 and antennae 208 to the list of individuals authorized to receive such information.

When a medical data set is dictated by a medical professional, the status is then changed to “Dictated” in the server 204 through the workstation 202. The data is then ready to be read by a medical professional. The messaging module that is part of the server 204 notifies appropriately designated individuals that the medical data is in the “Dictated” status. The messaging module may also identify the individual who dictated the data.

The data that has been “Dictated” may then be approved by another medical professional and the status (type) changed to “Approved”. As will be understood, after the data has been changed to the “Dictated” status, the messaging module within the server 204 may prepare a notification to the broadcast module 206 and antennae 208 to individuals who may be designated as performing the approval function.

An embodiment of the present invention provides a method 100 and apparatus 200 to notify radiologists that examination of medical data should commence. The present invention also provides a method 100 and apparatus 200 to minimize time lag between preparation of medical data and evaluation by medical professionals so that patients receive immediate care.

The method 100 and system 200 also minimizes the need for emergency examination readings that are not necessarily needed to be read or processed on an expedited basis.

The method 100 and system 200 in accordance with an embodiment of the present invention also discriminates between data types and subsequently allow notification of appropriate medical professionals based upon the data type required to be evaluated.

In the foregoing specification, the invention has been described with reference to specific exemplary embodiments thereof. It will, however, be evident that various modifications and changes may be made thereunto without departing from the broader spirit and scope of the invention as set forth in the appended claims. The specification and drawings are accordingly to be regarded in an illustrative rather than in a restrictive sense.

What is claimed is:

1. A method for notifying medical professionals of a need for evaluation of the medical scan, comprising:
enrolling a medical professional in a computer system, the enrolling of the medical professional including a medical professional type;
gathering medical data from a patient;
entering the medical data gathered from the patient, an urgency type for the patient, and a medical data type for the patient into a data archival system;
evaluating the urgency type for the patient related to the medical data; and
conducting a broadcast message to the medical professional with the medical professional type corresponding to the medical data type when the urgency type corresponds to a need for immediate reading of the medical data for the patient.

2. The method according to claim 1, wherein the urgency type for the patient is one of a modality categorization, an exam priority categorization, a study data categorization and a time categorization.

3. The method according to claim 1, further comprising:
verifying the urgency type for the patient after the step of evaluating the urgency type for the patient related to the medical data and before the step of conducting the broadcast message to the medical professional.

4. The method according to claim 1, further comprising:
reading the medical data by a medical professional.

5. The method according to claim 4, further comprising:
changing the urgency type in the data archival system after the reading of the medical data by the medical professional.

6. The method according to claim 1, wherein the medical data type is a magnetic resonance image.

7. The method according to claim 1, wherein the medical data type is a computed tomography image.

8. The method according to claim 1, further comprising:
creating a notification list of medical professionals of a same medical professional type; wherein the conducting of the broadcast message to the medical professional with the medical professional type corresponding to the medical data type when the urgency type corresponds to a need for immediate reading of the medical data for the patient is done through contacting medical professionals on the notification list.

9. A program storage device readable by machine, tangibly embodying a program of instructions executable by the machine to perform method steps for medical scan archiving and notifying medical professionals of a need for evaluation of the medical scan, comprising:
enrolling a medical professional in a computer system, the enrolling of the medical professional including a medical professional type;
gathering medical data from a patient;
entering the medical data gathered from the patient, an urgency type for the patient, and a medical data type for the patient into a data archival system;
evaluating the urgency type for the patient related to the medical data; and
conducting a broadcast message to the medical professional with the medical professional type corresponding to the medical data type when the urgency type corresponds to a need for immediate reading of the medical data for the patient.

10. The program storage device according to claim 9, wherein the urgency type for the patient is one of a modality categorization, an exam priority categorization, a study data categorization and a time categorization.

11. The program storage device according to claim 9, wherein the method further comprises:
verifying the urgency type for the patient after the step of evaluating the urgency type for the patient related to the medical data and before the step of conducting the broadcast message to the medical professional.

12. The program storage device according to claim 9, wherein the method further comprises reading the medical data by a medical professional.

13. The program storage device according to claim 12, wherein the method further comprises:
changing the urgency type in the data archival system after the reading of the medical data by the medical professional.

14. The program storage device according to claim 9, wherein the medical data type is a magnetic resonance image.

15. The program storage device according to claim 9, wherein the medical data type is a computed tomography image.

16. The program storage device according to claim 9, wherein the method further comprises:
creating a notification list of medical professionals of a same medical professional type; wherein the conducting of the broadcast message to the medical professional with the medical professional type corresponding to the medical data type when the urgency type corresponds to a need for immediate reading of the medical data for the patient is done through contacting medical professionals on the notification list.

17. An apparatus for medical data retention and medical professional notification, comprising:
a computer workstation configured to enter and display patient information medical data scans;
a broadcast module; and
a computer server connected to the computer workstation, the computer server configured to store the medical data scans patient information, the computer server also having a messaging module connected to the broadcast module, wherein the messaging module is configured to activate the broadcast module to send a message to a medical professional at a location remote from the computer workstation and the computer server based upon a predefined status of the patient information.
